(19) United States
(12) Patent Application Publication
(10) Pub. No.: US 2021/0305747 A1
(43) Pub. Date: Sep. 30, 2021

(54) Strain Relief and Wire Management System

(71) Applicant: Adrian Steel Company, Adrian, MI (US)

(72) Inventor: Thomas Scott Richter, Sand Creek, MI (US)

(73) Assignee: Adrian Steel Company, Adrian, MI (US)

(21) Appl. No.: 16/833,842

(22) Filed: Mar. 30, 2020

(51) Int. Cl. H01R 13/58; F16L 3/01

(52) U.S. Cl. CPC H01R 13/58; F16L 3/01

(57) ABSTRACT

One embodiment of a strain relief and wire management system is described. The system may have a wire conduit extending from a wire opening in a base portion. The system may also have fastener conduit extending from a fastener opening in the base portion. The system may also have a wire support extending from the base portion. The wire support may have a support portion and a retainer portion. The system may also have a channel guide extending from the base portion.

### FIELD

A strain relief and wire management system is disclosed. In one embodiment, the system may be used with vehicles, such as cargo or utility type vehicles, but other applications are permissible.

### BACKGROUND

Cargo vehicles are well-known vehicles. These vehicles may be used in certain industries, such as the trades, to transport cargo and equipment to job sites. In these capacities, the vehicles may be customized to transport specialized cargo and equipment. One example of such a customization may include cargo racks, including ladder racks and the like.

Some cargo racks and ladder racks may require wiring for electrical components. Often, however, these prior art devices do a poor job of accommodating the wiring. In these cases, the wiring is often left exposed to the elements which can degrade the wiring and may cause it to fail.

Attempts are also made to secure the wiring but these are often inadequate. For example, the devices used to secure the wiring pinches the wire, which can result in the sheathing on the wiring to prematurely wear or even break. A break in the sheathing can result in a short and expose the operator to an unpleasant electrical shock. Of course, a short can damage the electrical device the wiring is connected to, resulting in more damage to the vehicle.

Zip ties are often used to secure the wiring. Often, however, these ties are not robust enough to withstand the severe conditions on the outside of a working vehicle. In addition, the zip ties, as well as the other prior art solutions, look unprofessional especially if their loose ends are not trimmed after installation. The ties may also loosen over time, which permits the wires they are meant to secure to move and dangle.

The prior art solutions also fail to have a strain relief function. As a result, when the poorly secured wires move, they may pull against their connectors which can cause the connectors, and the electrical devices, to fail.

In view of the disadvantages associated with the prior art, it would be advantageous to have a strain relief and wire management system that permits a wire to be securely held in a way that did not result in its damage. It would also be advantageous for the system to handle wiring or cabling in a way that prolongs its life as well as provide a cleaner, more professional appearance to the vehicle.

### SUMMARY

In one embodiment, a strain relief and wire management system may have a wire conduit extending from a wire opening in a base portion. The system may also have a fastener conduit extending from a fastener opening in the base portion. The system may also have a wire support extending from the base portion; the wire support may have a support portion and a retainer portion. The system may also have a channel guide extending from the base portion.

In another aspect, the wire conduit, the base portion, the fastener conduit, the wire support and the channel guide may be one piece, integrally formed and unitary.

In another aspect, the base portion may have an upper surface and a lower surface. The surfaces may have at least a portion that are parallel one another to define a constant thickness between them.

In another aspect, the fastener conduit may have a substantially constant inner and outer diameter on an upper surface of the base portion.

In another aspect, one portion of the outer diameter of the fastener conduit may share a portion of a perimeter of the base portion, and another portion of the outer diameter of the fastener conduit may have a radially extending support portion.

In another aspect, the wire opening may be funnel-shaped on a lower surface on the base portion. The funnel-shape may transition to the wire conduit extending from an upper surface, where the wire conduit may be semi-cylindrical, and where a portion of the wire conduit may form a channel extending at a non-parallel angle to the wire conduit.

In another aspect, the wire support may comprise a support portion and a retainer portion, where the retainer portion may be sandwiched between the support portion.

In another aspect, the retainer portion may comprise two vertical extensions, each of the vertical extensions may define a prong.

In another aspect, the support portion may comprise two semi-circular walls extending upwardly from an upper surface of the base portion, where the two semi-circular walls may be separated by the vertical extensions.

In another aspect, the channel guide may comprise two ridges on a lower surface of the base portion, where the two ridges are parallel one another but may be separated from one another.

In another aspect, a first connector on an upper surface of the base portion may connect the wire conduit with the wire support and a second connector on the upper surface of the base portion may connect the wire support with the fastener conduit.

In another aspect, a strain relief and wire management system may have a wire conduit extending from a wire opening in a base portion. The system may also have a fastener conduit extending from a fastener opening in the base portion. The system may also have a wire support extending from the base portion; the wire support may comprise a support portion and a retainer portion. The system may also have a rail having at least one channel. The system may also have a channel guide extending from the base portion; the channel guide may be adapted to be selectively received within the channel.

In another aspect, the rail may have two channels at least a portion of which extend parallel one another, wherein each of the channels may have a base portion and two side portions extending from the base portion, wherein a gap may separate the side portions.

In another aspect, the wire opening and the wire conduit may be positioned above one of the channels and the fastener opening and the fastener conduit may be positioned above the other of the channels.

In another aspect, a fastener may be located through the fastener opening and the fastener conduit into one of the channels.

In another aspect, a bottom surface of the base portion may contact at least two side portions of the channels.

In another aspect, at least a portion of the wire conduit may be at least partially cylindrical and another portion of the wire conduit may form a channel extending at a non-parallel angle to the wire conduit.

In another aspect, the wire support may comprise a support portion and a retainer portion, wherein the retainer portion may be sandwiched between the support portion; the retainer portion may comprise two vertical extensions, and each of the vertical extensions may define a prong.

In another aspect, the support portion may comprise two semi-circular walls extending upwardly from an upper surface of the base portion, wherein the two semi-circular walls may be separated by the vertical extensions.

In another aspect, the channel guide may comprise two ridges on a lower surface of the base portion, wherein the two ridges may be parallel one another but are separated from one another.

### BRIEF DESCRIPTION OF THE DRAWINGS

The above, as well as other advantages, will become readily apparent to those skilled in the art from the following detailed description when considered in the light of the accompanying drawings in which:

FIG. 1 is a schematic perspective view of one embodiment of a strain relief and wire management system;

FIG. 2 is a schematic perspective view of the system of FIG. 1 in another condition;

FIG. 3 is a sectional view along line 3-3 of FIG. 2;

FIG. 4 is a schematic upper perspective view of the system in FIG. 1;

FIG. 5 is a schematic top view of the system in FIG. 1;

FIG. 6 is a schematic side view of the system in FIG. 1;

FIG. 7 is another schematic side view of the system in FIG. 1;

FIG. 8 is another schematic side view of the system in FIG. 1;

FIG. 9 is another schematic side view of the system in FIG. 1;

FIG. 10 is a schematic bottom view of the system of FIG. 1; and

FIG. 11 is a schematic lower perspective view of the system of FIG. 1.

### DETAILED DESCRIPTION OF THE PREFERRED EMBODIMENTS

It is to be understood that the system may assume various alternative orientations and step sequences, except where expressly specified to the contrary. It is also to be understood that the specific devices and processes illustrated in the attached drawings, and described in the following specification are simply exemplary embodiments. Hence, specific dimensions, directions or other physical characteristics relating to the embodiments disclosed are not to be considered as limiting.

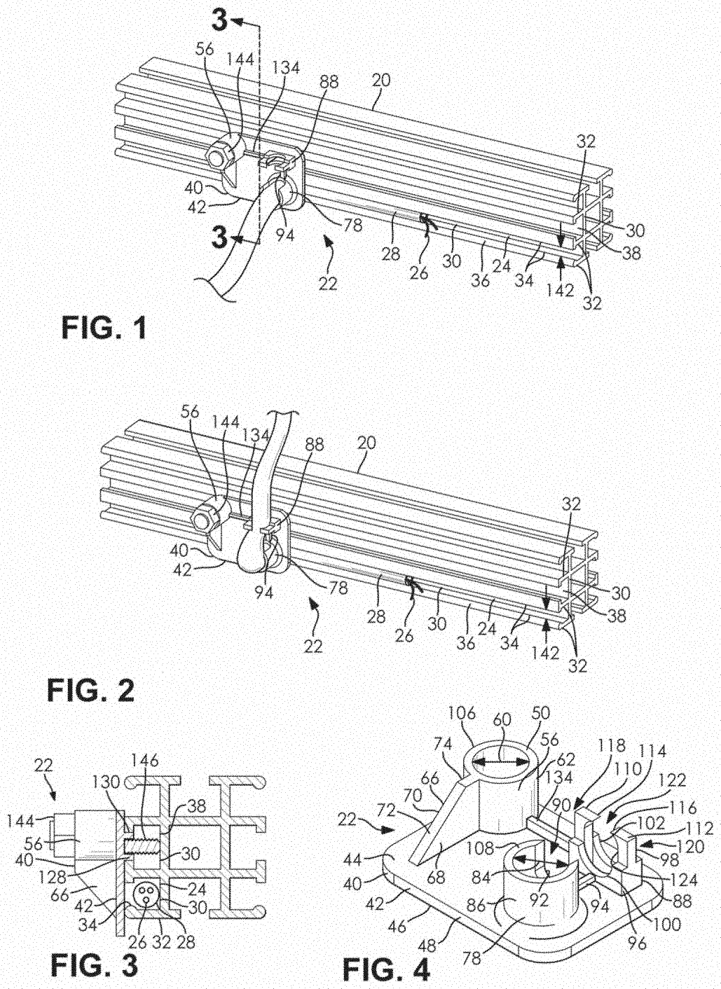

Turning now to FIGS. 1-3, one embodiment of a rail 20 is depicted. The rail 20 may be part of the strain relief and wire management system 22 or it may be separate therefrom. The rail 20 may be for interior or exterior use, such as within a vehicle or outside of a vehicle. In one embodiment, the rail 20 may be part of a cargo or ladder rack system of a vehicle. The rail 20 may be of any length and most any cross section. The rail 20 may be constructed of any material, including but not limited to, including polymer, composite and/or metal.

While use with a vehicle is mentioned, the system 22 is not limited to use with vehicles. Instead, the system 22 may be used in many other applications where a strain relief and wire management system 22 may be needed.

Preferably, at least one channel 24 is formed in the rail 20. The channel 24 may be extruded, machined or cast in the rail 20. The channel 24 may extend along any portion of the rail 20, including the entire rail 20. The channel 24 may extend continuously in a straight path or the channel 24 may be curvilinear.

In one embodiment, the channel 24 may have a U-shaped cross section, although other cross sections are permissible. The width of the channel 24 may vary also, but preferably, the width can at least accommodate an insulated wire 26. In one embodiment, a protective, flexible, corrugated sleeve 28 may be provided over the insulated wire 26. The channel 24 should ideally be able to accommodate the insulated wire 26, as well as the corrugated sleeve 28.

The type, or gauge, of the wire 26 is not important to the system 22. By way of example, the system 22 may accommodate wire gauges from 0 to 36 gauge wire; it is preferred that the system 22 includes the sleeve 28 that surrounds the wire 28.

The channel 24 may have a base portion 30 and two side portions 32 extending from the base portion 30 where the base portion 30 and the two side portions 32 define the U-shape cross-section. The side portions 32 may be parallel one another and perpendicular to the base portion 30 along the length of the channel 24. The side portions 32 may each have a lip 34 that is cantilevered over the base portion 30. Preferably, a continuous gap 36 separates the lips 34 from one another. The lips 34 may extend inwardly toward one another along a portion of, or the entire length of, the channel 24. The lips 34 may be parallel but non-planar with the base portion 30.

In the depicted embodiment, the rail 20 has a second channel 38 that extends equidistant from, and parallel to, the first channel 24. The second channel 38 may be the same as the first channel 24 in terms of cross-section and length.

Looking now at all the figures, an insert portion 40 of the strain relief and wire management system 22 may be integrally formed, unitary and one piece with itself; it may be separate from the rail 20. The insert portion 40 may be formed of metal, polymer and/or composite materials.

The insert portion 40 may be comprised of a base portion 42. The base portion 42 may have an upper surface 44 and a lower surface 46. Portions of the upper and lower surfaces 44, 46 may be planar. The surfaces 44, 46 may also have portions that are parallel one another thus defining a constant thickness between them. The base portion 42 may define a generally rectangular perimeter 48 but other shapes may be permissible.

In one embodiment, such as seen in FIG. 10, the lower surface 46 may be generally be divided into quadrants. The quadrants need not be physical components of the lower surface 46, but merely used for descriptive, or locating, purposes for certain features that are described below. Further, the numbering and/or ordering of the quadrants may be rearranged from what is used below.

As best seen in FIG. 10, the lower surface 46 may be divided into quadrants I-IV. In this example, quadrant I may be in the lower left of the lower surface 46, quadrant II may be in the upper left of the lower surface 46, quadrant III may be in the upper right of the lower surface 46 and quadrant IV may be in the lower right of the lower surface 46.

A fastener opening 50 may be located in quadrant I. The fastener opening 50 may be offset from center in the quadrant. More particularly, the fastener opening 50 may be located closer to an outer corner portion 52 of the quadrant than an intersection 54 of the four quadrants. In one embodiment, the fastener opening 50 may be a circular opening in the lower surface 46.

The fastener opening 50 may extend through the base portion 42. The fastener opening 50 may extend to a fastener conduit 56 that extends upward from the upper surface 44 of the base portion 42. As shown in the exemplary figures, the fastener conduit 56 may have a constant inner diameter 58 and a constant outer diameter 60, resulting in a substantially constant thickness of the fastener conduit 56 on the upper surface 44 of the base portion 42. The fastener conduit 56 may form a generally cylindrical structure on the upper surface 44 of the base portion 42.

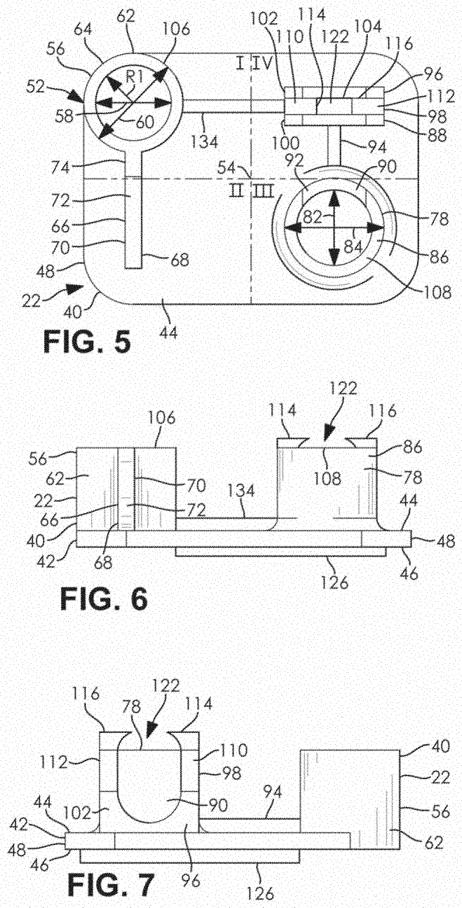

An outer surface 62 of the fastener conduit 56 on the upper surface 44 may share a portion of the perimeter 48 of the base portion 42, as may be seen in FIG. 5. More particularly, the outer surface 62 of the fastener conduit 56 may share a corner portion 64 of the base portion 42 perimeter 48 as the two may have the same radius of curvature R1.

A portion of the outer surface 62 of the fastener conduit 56 distal from the shared perimeter portion may have a support portion 66 connected thereto. In the depicted embodiment, the support portion 66 may be integrally formed, one piece and unitary with the fastener conduit 56. As shown in the exemplary figures, the support portion 66 may extend substantially radially outward from the outer surface 62.

The support portion 66 may have an inner surface 68 and an opposite, outer surface 70. The outer surface 70 may be located nearer the outer perimeter 48 of the base portion 42 compared with the inner surface 68. In one embodiment, the inner and outer surfaces 68, 70 may extend parallel with most of the adjacent outer perimeter 48. The two surfaces 68, 70 may define a constant thickness between them.

As shown in certain figures, the support portion 66 may comprise a ramped portion 72. The ramped portion 72 may begin at the upper surface 44 of the base portion 42 where it may extend upward from the upper surface 44 as it approaches the fastener conduit 56. In some embodiments, the ramped portion 72 may extend to a planar portion 74. The planar portion 74 may be coplanar with an upper surface 75 of the fastener conduit 56.

As with the lower surface 46, the upper surface 44 of the base portion 42 may be divided into quadrants I-IV. The quadrants on the upper surface 44 match the quadrants on the lower surface 46, as can be appreciated from FIGS. 5 and 6. For example, the fastener opening 50 is located in quadrant I of the lower surface 46 and the fastener conduit 56 is located in quadrant I of the upper surface. 44 Other features described herein are similarly located.

From the above, it can be appreciated that the support portion 66 extends from the fastener conduit 56 in quadrant I and extends into quadrant II on the upper surface 44. The support portion 66 may provide support and rigidity to the fastener conduit 56.

Turning now back to FIG. 10, a wire opening 76 may be located in quadrant III, thus the wire opening 76 is in a diagonal quadrant from the fastener opening 50. The wire opening 76 may funnel into a wire conduit 78. While a funnel 80 transition may be provided, other transitions are permissible. The funnel 80 may have a larger diameter than the wire opening 76. A funnel 80 may be used to assist a wire 26 and/or wire/sleeve 28 combination to fit within the wire opening 76.

The wire opening 76 may extend through the base portion 42 to the wire conduit 78 that extends upward from the upper surface 44 of the base portion 42.

As shown in the exemplary figures, the wire conduit 78 may have a constant inner diameter 82 and a constant outer diameter 84, resulting in a substantially constant thickness of the wire conduit 78 on the upper surface 44 of the base portion 42. At least a portion of the wire conduit 78 extending upwardly on an upper surface 44 of the base portion 42 may form a generally cylindrical structure.

As can be appreciated from the figures, the wire conduit 78 may be offset from the perimeter 48 of the base portion 42, as may be seen for example in FIG. 5. From this figure, it can be observed that the wire conduit 78 is located in quadrant III on the upper surface 44.

The wire conduit 78 may have a portion of its cylindrical wall 86 removed. In one embodiment, probably best seen in FIGS. 4-5 and 7, the wire conduit 78 may have approximately a half to a quarter of the total circumference of the wall 86 removed. The portion of the wall 86 that is removed may be a portion that faces toward a wire support 88, which is described in more detail below. The removed wall portion creates a channel 90. The channel 90 extends at an angle to the primary direction of the wire conduit 78; the angle may be such as perpendicular. The channel 90 faces quadrant IV.

With a portion of the wall removed, the wire conduit 78 above the upper surface 44 has a full wall portion 86 and a partial wall portion 92. The partial wall portion 92 may only comprise approximately one quarter to a half the full wall portion 86 of the wire conduit 78.

A first connector piece 94 may extend from the partial wall portion 92 of the wire conduit 78 to the wire support 88. Thus, the first connector piece 94 may continuously extend from quadrant III to quadrant IV, where the wire support 88 is located. The first connector piece 94 may have a rectangular, or square, cross section along its entire length. By connecting the wire conduit 78 to the wire support 88, the first connector piece 94 adds rigidity and strength to both the wire conduit 78 and the wire support 88.

The wire support 88 may be comprised of a support portion 96 and a retainer portion 98. The support portion 96 may be separated by, such as divided by, the retainer portion 98. For example, as shown in the figures, particularly FIG. 4, the support portion 96 may be comprised of two semi-circular walls 100, 102 that extend upward from the base portion 42 where the walls 100, 102 are separated from one another by the retainer portion 98. The semi-circular walls 100, 102 only extend a portion of the retainer portion 98 height.

One of the semi-circular walls, such as the inner wall 100, receives the first connector piece 94. The other wall, the outer wall 102, may be opposite the inner wall 100; the outer wall 102 is closer to a larger portion of the perimeter 48 than the inner wall 100. The two walls 100, 102 may extend parallel a portion of the perimeter 48. Further, the two walls 100, 102 may extend parallel one another. In fact, the two walls 100, 102 may be of the same size, and shape as one another.

The two walls 100, 102 may be separated from one another by an aperture 104. The aperture 104 may extend through the base portion 42. The aperture 104 may have a generally rectangular cross section with the two walls 100, 102 extending parallel to the two long sides of the rectangular aperture 104. These features may be seen in FIGS. 5 and 10.

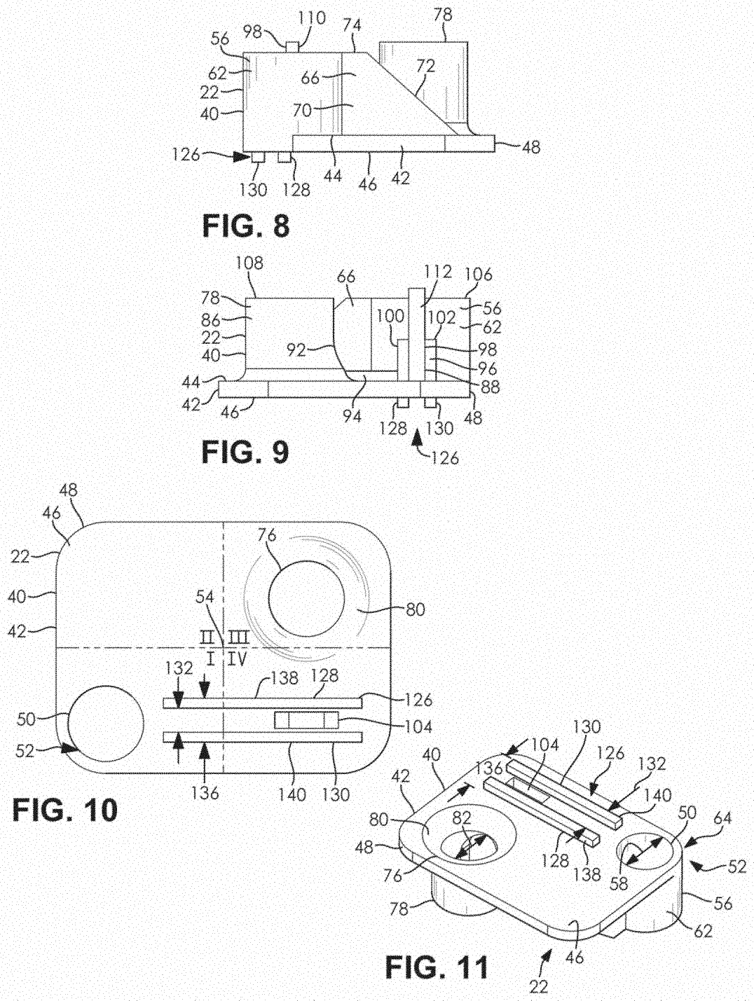

The retainer portion 98 may extend between, and rise above, the support portion 96, as shown in FIGS. 5 and 9. By way of one example, the retainer portion 98 may be sandwiched between the two walls 100, 102. In one embodiment, the retainer portion 98 may extend above an upper surface 44 of the fastener conduit 106 and an upper surface 108 of the wire conduit 78, which may be appreciated from FIGS. 6-9.

The retainer portion 98 may comprise two vertical extensions 110, 112 that may be of the same size and shape as one another. The vertical extensions 110, 112 may be located along the short sides of the rectangular aperture 104. In this location, one vertical extension may be designated an inner vertical extension 110 and the other an outer vertical extension 112. Thus, the vertical extensions 110, 112 and the walls 100, 102 may fully surround the aperture 104 on the upper surface 44 of the base portion 42.

The vertical extensions 110, 112 may each have a prong 114, 116 on respective uppermost end portions 118, 120. The prongs 114, 116 preferably extend toward one another, but they do not have to touch. Instead, there may be a gap 122 that separate the prongs 114, 116; a larger gap 124 may separate the vertical extensions 110, 112.

Looking again at FIG. 10, quadrant IV of the lower surface 46 may have a channel guide 126. In the depicted embodiment, the channel guide 126 may be such as an inner ridge 128 and an outer ridge 130 on the lower surface 46. The ridges 128, 130 may have the same cross-sectional shape as one another and/or the ridges 128, 130 may be parallel one another. The ridges 128, 130 may extend approximately from one perimeter edge toward the fastener opening 50, and run parallel another perimeter edge. The ridges 128, 130 may also be located between a perimeter edge and the wire opening 76. The rectangular aperture 104 that extends through the base portion 42 may be located between a portion of the two ridges 128, 130. The two ridges 128, 130 preferably extend parallel the long sides of the rectangular aperture 104. Thus, the two ridges 128, 130 may be separated from one another by a constant gap 132. The two ridges 128, 130 may extend parallel but are not coplanar with the walls 100, 102 of the support portion 96.

Turning to FIGS. 4 and 5, a second connector piece 134 may extend from the retainer portion 98 to the fastener conduit 56. More particularly, the second connector piece 134 may extend from the inner vertical extension 110 to the outer surface 62 of the fastener conduit 56. Thus, the second connector piece 134 may continuously extend from quadrant IV to quadrant i. The second connector piece 134 may have a rectangular, or square, cross section along its entire length. By connecting the retainer portion 98 to the fastener conduit 56, the second connector piece 134 adds rigidity and strength to both the retainer portion 98 and the fastener conduit 56.

Turning back to FIGS. 1-3, one embodiment of the system 22 installed on a rail 20 is schematically depicted. In this embodiment, the ridges 128, 130 on the lower surface 46 have been located in the second channel 38. The ridges 128, 130 secure the system 22 to the rail 20, but still permit the system 22 to selectively move along the rail 20.

In one embodiment, a distance 136 between outer surfaces 138, 140 of the ridges 128, 130 is slightly less than a distance 142 between the lips 34 of the channel 38. This permits the ridges 128, 130 to be securely retained by the lips 34 to prevent removal from the second channel 38 but relative sliding motion of the system 22 with respect to the rail 22 is permitted.

A fastener 144 is depicted within the fastener conduit 56. In this embodiment, the fastener 144 may be located within the conduit 56 so that a bottom portion 146 of the fastener 144 contacts the base portion 30 of the second channel 38. The bottom portion of the fastener 144 may be located in an aperture (not shown) in the second channel 38 to secure the fastener 144 to the second channel 38. In this condition, the fastener 144 prevents the system 22 from moving along the rail 20 and the system 22 is fixed in place. It can be appreciated that the system 22 can be moved along the rail 20 to a predetermined location, and then the fastener 144 can be threaded down through the fastener conduit 78 until it contacts the base portion 30 of the second channel 38 (or an aperture therein) to anchor the system 22 in place.

The wire 26 within the sleeve 28 is depicted in the first channel 24. The first channel 24 thus functions to guide, to protect and to hide the wire and sleeve 28. The wire 26 and sleeve 28 may be extended through the wire opening 76 and the wire conduit 78 of the system 22. This may involve transitioning the wire 26 and sleeve 28 approximately 90 degrees from their direction in the first channel 24 through the wire conduit 78. The wire 26 and sleeve 28 may also be routed through another 90 degree turn through the channel 90 in the wire conduit 78. The wire 26 and sleeve 28 are now oriented toward the wire support 88. They can be extended through the support portion 96 and the retainer portion 98. The wire 26 and sleeve 28 may be supported from below by the support portion 96 and retained in place by the retainer portion 98 and its prongs 114, 116.

In the installed condition, the lower surface 46 of the base portion 42 of the insert portion 40 rests on certain side portions 32 of the first and second channels 24, 38. More particularly, the lower surface 46 may rest on the lips 34 of the rail channels 24, 38. The base portion 42 thus spans the gaps 142 between the two lips 34. In this embodiment, the wire opening 76 and the wire conduit 78 are located over the first channel 24 and the fastener opening 50 and the fastener conduit 56 are located over the second channel 38. Thus, the wire 26 and sleeve 28 are located in the first channel 24 and the fastener is located in the second channel 38.

From the above it can be appreciated that the wire 26 and sleeve 28 are thus supported and managed so that they are securely located in a precise location. It can also be appreciated that the wire 26 and sleeve 28 being so secured are prevented from being strained, thus preserving their function and longevity.

In accordance with the provisions of the patent statutes, the device has been described in what is considered to represent its preferred embodiments. However, it should be noted that the device can be practiced otherwise than as specifically illustrated and described without departing from its spirit or scope.

What is claimed is:

1. A strain relief and wire management system, comprising:
a wire conduit extending from a wire opening in a base portion;
a fastener conduit extending from a fastener opening in the base portion;
a wire support extending from the base portion, said wire support comprising a support portion and a retainer portion; and
a channel guide extending from the base portion.

2. The system of claim 1, wherein said wire conduit, said base portion, said fastener conduit, said wire support and said channel guide are one piece, integrally formed and unitary.

3. The system of claim 1, wherein said base portion has an upper surface and a lower surface, said surfaces having at least a portion that are parallel one another to define a constant thickness between them.

4. The system of claim 1, wherein said fastener conduit has a substantially constant inner and outer diameter on an upper surface of said base portion.

5. The system of claim 4, wherein one portion of said outer diameter of said fastener conduit shares a portion of a perimeter of the base portion, and another portion of said outer diameter of said fastener conduit has a radially extending support portion.

6. The system of claim 1, wherein said wire opening is funnel-shaped on a lower surface on said base portion, said funnel-shape transitioning to said wire conduit extending from an upper surface, wherein said wire conduit is semi-cylindrical, and wherein a portion of said wire conduit forms a channel extending at a non-parallel angle to said wire conduit.

7. The system of claim 1, wherein said retainer portion is sandwiched between two parts of said support portion, and wherein an aperture extends through said base portion, said aperture located between said retainer portion and said two parts of the support portion.

8. The system of claim 7, wherein said retainer portion comprises two vertical extensions, each of said vertical extensions defining a prong.

9. The system of claim 8, wherein said support portion comprises two semi-circular walls extending upwardly from an upper surface of the base portion, wherein said two semi-circular walls are separated by said vertical extensions.

10. The system of claim 1, wherein said channel guide comprises two ridges on a lower surface of the base portion, wherein said two ridges are parallel one another but are separated from one another.

11. The system of claim 1, wherein a first connector on an upper surface of the base portion connects the wire conduit with the wire support and a second connector on the upper surface of the base portion connects the wire support with the fastener conduit.

12. A strain relief and wire management system, comprising:
a wire conduit extending from a wire opening in a base portion;
a fastener conduit extending from a fastener opening in the base portion;
a wire support extending from the base portion, said wire support comprising a support portion and a retainer portion;
a rail having at least one channel; and
a channel guide extending from the base portion, said channel guide adapted to be selectively received within said channel.

13. The system of claim 12, wherein said rail has two channels at least a portion of which extend parallel one another, wherein each of said channels has a base portion and two side portions extending from the base portion, wherein a gap separates said side portions.

14. The system of claim 13, wherein said wire opening and said wire conduit are positioned above one of said channels and said fastener opening and said fastener conduit are positioned above the other of said channels.

15. The system of claim 13, wherein a fastener is located through said fastener opening and said fastener conduit into one of said channels.

16. The system of claim 13, wherein a bottom surface of said base portion contacts at least two side portions of said channels.

17. The system of claim 12, wherein at least a portion of said wire conduit is at least partially cylindrical and another portion of said wire conduit forms a channel extending at a non-parallel angle to said wire conduit.

18. The system of claim 12, wherein said wire support comprises a support portion and a retainer portion, wherein said retainer portion is sandwiched between said support portion, said retainer portion comprises two vertical extensions, each of said vertical extensions defining a prong.

19. The system of claim 12, wherein said support portion comprises two semi-circular walls extending upwardly from an upper surface of the base portion, wherein said two semi-circular walls are separated by said vertical extensions.

20. The system of claim 12, wherein said channel guide comprises two ridges on a lower surface of the base portion, wherein said two ridges are parallel one another but are separated from one another.
